(19) United States
(12) Patent Application Publication
(10) Pub. No.: US 2013/0282923 A1
(43) Pub. Date: Oct. 24, 2013

(54) MANAGING OVERLAPPING ADDRESS DOMAINS

(71) Applicants: Joseph Elisha Taylor, Ft. Collins, CO (US); Wei Wen Chen, Fort Collins, CO (US); Zhenjun Cao, Superior, CO (US); Max C. Knees, Fort Collins, CO (US); Lawrence M. Besaw, Severance, CO (US); Peter C. Zwetkof, Greeley, CO (US)

(72) Inventors: Joseph Elisha Taylor, Ft. Collins, CO (US); Wei Wen Chen, Fort Collins, CO (US); Zhenjun Cao, Superior, CO (US); Max C. Knees, Fort Collins, CO (US); Lawrence M. Besaw, Severance, CO (US); Peter C. Zwetkof, Greeley, CO (US)

(21) Appl. No.: 13/452,577

(22) Filed: Apr. 20, 2012

(51) Int. Cl. G06F 15/16

(52) U.S. Cl. 709/245

(57) ABSTRACT

A system and method for managing overlapping address domains are described herein. The method includes receiving, at a global network node management system, communications from a plurality of tenants within a network address translation (NAT) environment, wherein each of the plurality of tenants includes a group of network devices with non-overlapping internet protocol (IP) addresses. The method also includes tracking, via the global network node management system, a state of the NAT environment based on the communications.

### BACKGROUND

Many customer networks exist that contain overlapping address domains (OADs). Such OADs are typically configured because customers do not have enough internet protocol (IP) address space available to assign every network device a unique, routable IP address. As a result, it is common for customers to use network address translation (NAT) to map scarce IP addresses, e.g., public IP addresses, to more abundant IP addresses, e.g., private IP addresses. However, this may result in difficulties in network management and monitoring by making the public and private IP address mappings difficult to understand by the network management tools. For example, management tools may misclassify overlapping IP addresses as a network error, or may not be able to understand the network topology correctly.

### BRIEF DESCRIPTION OF THE DRAWINGS

Certain examples are described in the following detailed description and in reference to the drawings, in which:

FIG. 1 is a block diagram of a computing system that may be used for managing overlapping address domains (OADs);

FIG. 2 is a schematic of a static network address translation (NAT) environment;

FIG. 3 is a schematic of a dynamic NAT environment;

FIG. 4 is a schematic of a NAT environment including both the static NAT environment and the dynamic NAT environment;

FIG. 5 is a schematic of a global NNM system that is communicably coupled to a number of regional NNM systems;

FIG. 6 is a schematic of a NAT environment in which an NNM system is used to monitor a first tenant and a second tenant;

FIG. 7 is a schematic of a NAT environment in which an NNM system is used to monitor a number of tenants;

FIG. 8 is a schematic of a dynamic NAT environment in which a global NNM system is used to monitor a number of tenants;

FIG. 9 is a process flow diagram showing a method for managing OADs using a global NNM system; and

FIG. 10 is a block diagram showing a tangible, non-transitory, computer-readable medium that stores a protocol adapted to manage OADs within a NAT environment using one or more NNM systems.

### DETAILED DESCRIPTION OF SPECIFIC EXAMPLES

Techniques described herein relate generally to the management of overlapping address domains (OADs) within a network address translation (NAT) environment. As used herein, the term “overlapping address domain” (OAD) refers to an internet protocol (IP) address domain that is not unique. OADs may be used to map scarce, external IP addresses to more abundant, internal IP addresses. In addition, the term “network address translation” (NAT) refers to the process of interconnecting a local network to the public, or external, network, wherein the local network runs on a block of private, or internal, IP addresses. More specifically, NAT translates IP header information, substituting public IP addresses for private IP addresses in IP packets that are to be transmitted across the public network. NAT accomplishes this by providing public to private IP address mapping.

NAT may allow for the connection of a large number of hosts to a global network using a single public, or external, IP address, thereby conserving IP address space. NAT may also enable the reuse of internal, or private, IP addresses. In addition, NAT may enhance security for private networks by keeping internal addressing private from the external network.

Techniques described herein may relate to both static NAT and dynamic NAT. As used herein, the term “static NAT” refers to a type of network address translation in which a private, or internal, IP address is mapped to a public, or external, IP address, wherein the public IP address does not change. Static NAT enables an internal host, such as a Web server, to have an unregistered, private IP address and still be reachable over the network.

As used herein, the term “dynamic NAT” refers to a type of network address translation in which bindings between public IP addresses and private IP addresses can change between sessions. According to dynamic NAT, a private IP address may be mapped to a public IP address, drawing from a number of available registered, public IP addresses. Typically, a NAT router in a network keeps a table of registered IP addresses. Then, when a private IP address requests access to the network, the NAT router chooses an IP address from the table that is not currently being used by another private IP address.

As used herein, the term “port address translation” (PAT) refers to a type of dynamic NAT in which both the IP address and the port address are translated, or mapped, to a public IP address. PAT may also be referred to as “network address and port translation” (NAPT). Translating both the IP address and the port address may allow a single public address to be used for multiple simultaneous private address conversations over the network.

A network node management (NNM) system may be used to manage areas of a network that include overlapping IP addresses resulting from implementing NAT. As used herein, the term “network node” refers to a particular network device, or group of network devices, within a network computing environment. In various examples, an NNM system is configured to manage OADs within a NAT environment using tenancy.

As used herein, the term “tenancy” refers to a logical grouping concept that provides network node grouping, mapping, and security support. Further, the term “tenant” refers to a single address domain space. As an example, a tenant may be a particular customer within an Internet provider's network. In addition, within a particular tenant domain, IP addresses are not overlapping. Thus, in some examples, the tenants that are associated with the network nodes stored within the NNM system may be used as artificial boundaries for the creation of network topology for the NNM system.

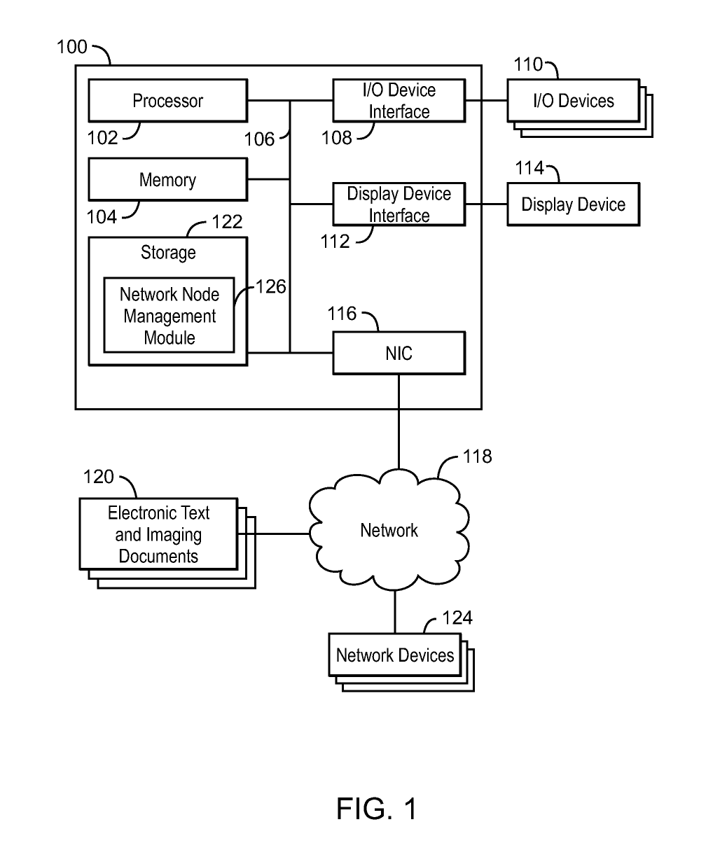

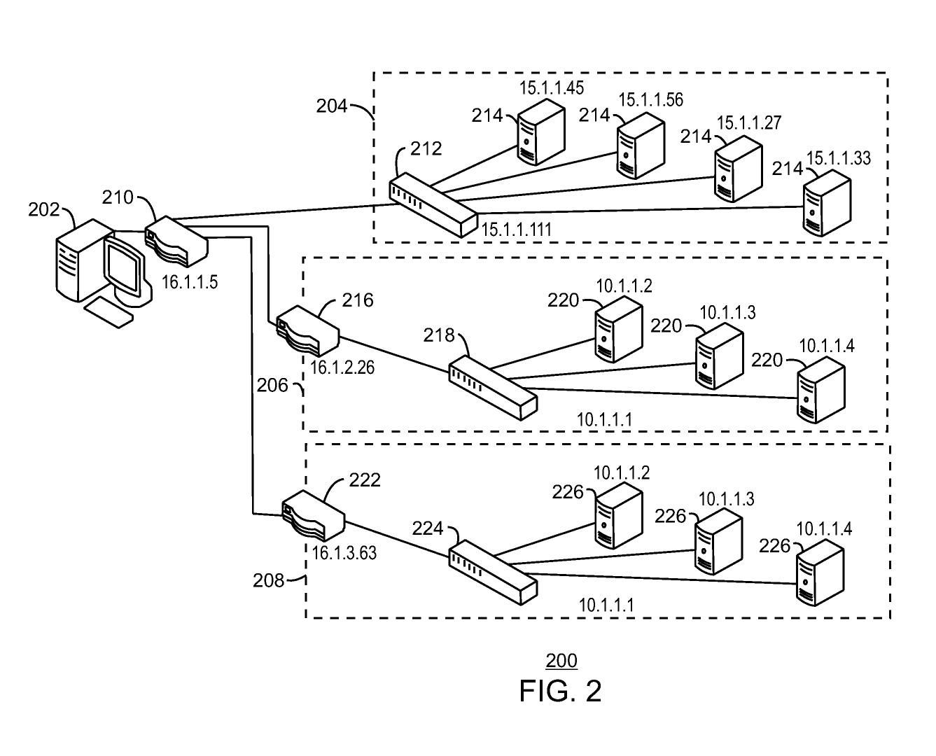

FIG. 1 is a block diagram of a computing system 100 that may be used for managing overlapping address domains. The computing system 100 may be, for example, a mobile phone, laptop computer, desktop computer, tablet computer, or network server, among others. The computing system 100 may be a global NNM system that is configured to manage OADs within a static or dynamic NAT environment, as discussed further below with respect to FIGS. 2-4. In addition, the computing system 100 may be included within a network computing environment, such as a cloud computing environment.

The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (RAM), read only memory (ROM), flash memory, or any other suitable memory systems. The instructions that are executed by the processor 102 may be used to implement a method that includes managing overlapping address domains within a network computing environment.

The processor 102 may be connected through a bus 106 to an input/output (I/O) device interface 108 adapted to connect the computing system 100 to one or more I/O devices 110. The I/O devices 110 may include, for example, a keyboard and a pointing device, wherein the pointing device may include a touchpad or a touchscreen, among others. The I/O devices 110 may be built-in components of the computing system 100, or may be devices that are externally connected to the computing system 100.

The processor 102 may also be linked through the bus 106 to a display interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100.

A network interface card (NIC) 116 may be adapted to connect the computing system 100 through the bus 106 to a network 118. The network 118 may be a wide area network (WAN), local area network (LAN), or the Internet, among others. Through the network 118, the computing system 100 may access electronic text and imaging documents 120. The computing system 100 may also download the electronic text and imaging documents 120 and store the electronic text and imaging documents 120 within a storage device 122 of the computing system 100.

Through the network 118, the computing system 100 may be communicably coupled to a number of network devices 124. The network devices 124 may include, for example, desktop computers, laptop computers, printers, or network servers, among others. In addition, the network devices 124 may include one or more regional network node management systems that are configured to send information pertaining to other network devices to the computing system 100.

The storage device 122 can include a hard drive, an optical drive, a thumbdrive, an array of drives, or any combinations thereof. The storage device 122 may include a global NNM module 126 that is configured to monitor the state, or health, of the network devices 124 that are communicably coupled to the computing system 100. In some examples, the global NNM module 126 allow for the determination of specific network devices 124 from which to collect information. The specific network devices 124 may be determined automatically, or in response to input from a user of the computing system 100.

It is to be understood that the block diagram of FIG. 1 is not intended to indicate that the computing system 100 is to include all of the components shown in FIG. 1. Further, the computing system 100 may include any number of additional components not shown in FIG. 1, depending on the specific application.

FIG. 2 is a schematic of a static NAT environment 200. The static NAT environment 200 may include an NNM server 202. For example, the NNM server 202 may be the computing system 100 discussed above with respect to FIG. 1. The static NAT environment 200 may also include a number of tenants, including a default tenant 204, a first static NAT tenant 206, and a second static NAT tenant 208. Further, any number of additional tenants not shown in FIG. 2 may be included within the NAT environment 200.

The NNM server 202 may be communicably coupled to a primary router 210 that is configured to connect the NNM server 202 to the tenants 204, 206, and 208. For example, the primary router 210 may be connected to a network switch 212 within the default tenant 204. The network switch 212 may include a number of ports that are adapted to communicably couple a number of network devices 214 to the network switch 212. Each of the network devices 214 within the default tenant 204, as well as the network switch 212, may include a unique, non-overlapping external IP address, as shown in FIG. 2.

In addition, according to examples described herein, cross-tenant connectivity between any of the tenants 206 or 208 other than the default tenant 204 is not allowed. In other words, the tenants 206 and 208 are isolated from each other. However, cross-tenant connectivity between any of the tenants 206 or 208 and the default tenant 204 may be allowed.

The primary router 210 may also be communicably coupled to a secondary router 216 within the first static NAT tenant 206. The secondary router 216 may be connected to a network switch 218 within the first static NAT tenant 206, among other devices. The network switch 218 may include a number of ports that are adapted to communicably couple a number of network devices 220 to the network switch 218. Each of the network devices 220 within the first static NAT tenant 206 may include a unique, non-overlapping internal IP address.

In addition, the primary router 210 may be communicably coupled to another secondary router 222 within the second static NAT tenant 208. The secondary router 222 may be connected to a network switch 224 within the second static NAT tenant 208, among other devices. The network switch 224 may include a number of ports that are adapted to communicably couple a number of network devices 226 to the network switch 224. Each of the network devices 226 within the second static NAT tenant 208 may include a unique, non-overlapping internal IP address.

In the example shown in FIG. 2, the internal IP addresses of the network devices 220 within the first static NAT tenant 206 may be the same as the internal IP addresses of the network devices 226 within the second static NAT tenant 208. However, the external IP address of the first static NAT tenant 206 may be different from the external IP address of the second static NAT tenant 208, as shown in FIG. 2. Thus, the separation of the network devices 220 and 226 into groups of network devices 220 or 226 with non-overlapping internal IP addresses may allow for the management of OADs within the static NAT environment 200.

It is to be understood that the schematic of FIG. 2 is not intended that all of the components shown in FIG. 2 are to be included within the static NAT environment 200 in every case. Any number of additional components may also be included within the static NAT environment 200, depending on the specific application. Further, the routers 210, 216, and 222 may be any type of gateway device. In addition, each of the routers 210, 216, and 222 may include a corresponding modem. The network devices 214, 220, and 226 may be any type of computing device that is capable of being communicably coupled to a network, such as a server, a laptop computer, desktop computer, or mobile phone, among others.

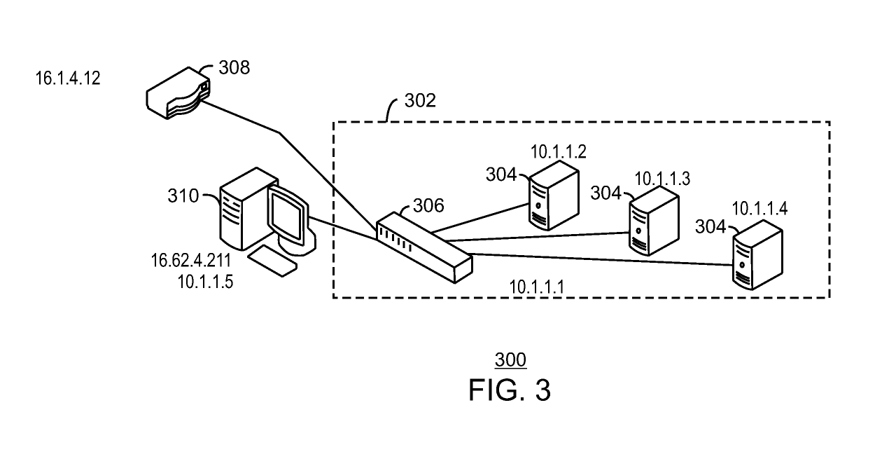

FIG. 3 is a schematic of a dynamic NAT environment 300. In some examples, the dynamic NAT environment 300 is a dynamic PAT environment. The dynamic NAT environment 300 may include a dynamic NAT tenant 302. The dynamic NAT tenant 302 may include a number of network devices 304 that are configured to be communicably coupled to the network via a network switch 306 and a router 308. Each of the network devices 304 may include a unique, non-overlapping internal IP address, and the router 308 may include a unique external IP address.

In addition, the dynamic NAT environment 300 may include an NNM server 310 that is configured to manage the dynamic NAT tenant 302. In some examples described herein, the NNM server 310 manages only one dynamic NAT domain, wherein all network nodes, e.g., network devices 304, within the dynamic NAT domain belong to the same dynamic NAT tenant 302. The NNM servers 310 may include both an internal and an external IP address, as shown in FIG. 3.

The NNM server 310 may be a regional NNM server that is communicably coupled to a global NNM server (not shown) via the router 308. In such examples, the regional NNM server 310 is directly responsible for the management of the dynamic NAT tenant 302. The global NNM server may be responsible for monitoring the functioning of the dynamic NAT tenant 302 that is managed by the regional NNM server 310, as well as any number of additional dynamic NAT tenants (not shown) that are managed by other regional NNM servers (not shown).

It is to be understood that the schematic of FIG. 3 is not intended that all of the components shown in FIG. 3 are to be included within the dynamic NAT environment 300 in every case. Any number of additional components may also be included within the dynamic NAT environment 300, depending on the specific application. In some examples, the router 308 may be any type of gateway device. The network devices 304 may be any type of computing device that is capable of being communicably coupled to a network, such as a server, laptop computer, desktop computer, or mobile phone, among others. In addition, the NNM server 310 may be any type of computing device that is capable of performing management functions, such as a laptop computer, desktop computer, or mobile phone, among others.

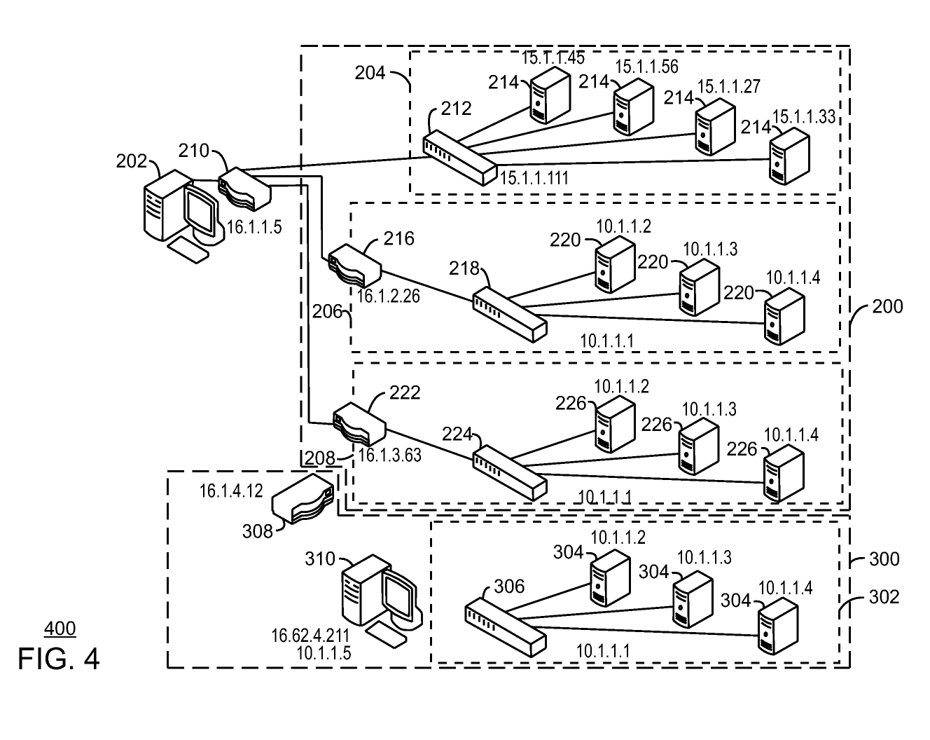

FIG. 4 is a schematic of a NAT environment 400 including both the static NAT environment 200 and the dynamic NAT environment 300. Like numbered items are as described with respect to FIGS. 2 and 3. According to the example shown in FIG. 4, the NNM server 202 acts as the global NNM server. The global NNM server 202 may be used to monitor the network devices 214, 220, 226, and 304 within both the static NAT environment 200 and the dynamic NAT environment 300. The global NNM server 202 may be communicably coupled to the static NAT environment 200 and the dynamic NAT environment 300 via the primary router 210. In addition, the global NNM server 202 may reside outside the NAT firewall.

As discussed above, the dynamic NAT tenant 302 may be managed by the regional NNM server 310. However, the first static NAT tenant 206 and the second static NAT tenant 208 may be managed directly by the global NNM server 210. Overlapping address domains between the first static NAT tenant 206 and the second static NAT tenant 208 may be overcome using the secondary router 216 and the secondary router 222, respectively, to separate the first static NAT tenant 206 and the second static NAT tenant 208 into two address domains with differing external IP addresses. In addition, the default tenant 204 may be managed directly by the global NNM server 210, and may be communicably coupled to the global NNM server 210 via the primary router 210.

The regional NNM server 310 may send network communications relating to the state of the dynamic NAT tenant 302 to the global NNM server 210. Such network communications may include, for example, the inventory, status, and incidents for the dynamic NAT environment 300. This information may be used by the global NNM server 302 to determine the overall network topology of the NAT environment 400.

It is to be understood that the schematic of FIG. 4 is not intended to indicate that all of the components shown in FIG. 4 are to be included within the NAT environment 400 in every case. Any number of additional components may also be included within the NAT environment 400, depending on the specific application. In some examples, the default tenant 204 may include the provider network, e.g., the area of the NAT environment 400 that is administered by the network service provider, while the other tenants 206, 208, or 302 may include the customer network, e.g., the area of the NAT environment 400 that is administered by the network service customers. In addition, the provider network and the customer network may be connected via a provider edge (PE) and a customer edge (CE), which may include routers or any other types of gateway devices. A directional path analysis algorithm may be used to determine the correct connectivity for the provider network to the customer network via the PE and the CE. For example, the NAT environment 400 may allow for cross-tenant connectivity, e.g., L2 connectivity, between the provider network and the customer network. This may allow an administrator of the NAT environment 400 to include administrator network devices in the default tenant 204 and customer network devices in customer-specific tenants 206, 208, or 302. Due to the cross-tenant connectivity, the administrator may then be provided with access to all of the customer network devices, or network nodes, within the NAT environment 400.

The NAT environment 400 may also allow for the duplication of subnetworks (subnets) in different tenants 204, 206, 208, or 302. This enables the global NNM server 210 to create small subnet connections, e.g., L3 connections, based on configured subnet connection rules across multiple tenants 204, 206, 208, or 302. In various examples, such subnet connections are allowed between the default tenant 204 and any of the other tenants 206, 208, or 302. However, such subnet connections are not allowed between any of the tenants 206, 208, or 302 other than the default tenant 204.

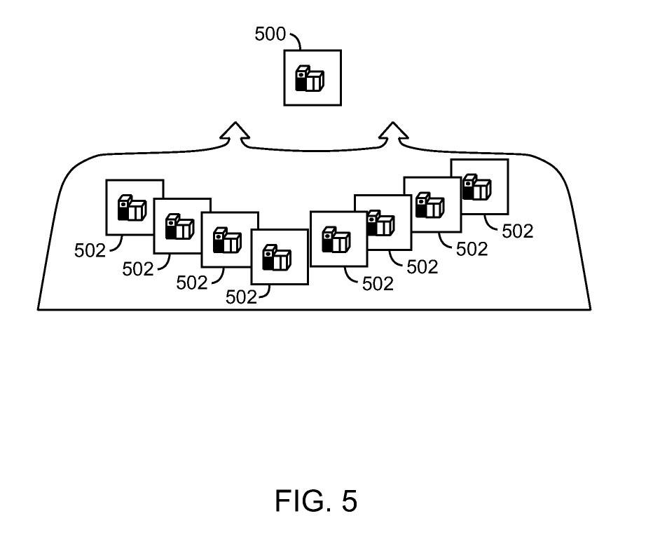

FIG. 5 is a schematic of a global NNM system 500 that is communicably coupled to a number of regional NNM systems 502. The global NNM system 500 may be communicably coupled to the regional NNM systems 502 via a network, such as a WAN, LAN, or the Internet. The global NNM system 500 may be configured to receive information from any number of the regional NNM systems 502. In addition, the global NNM system 500 may be configured to use such information to monitor a number of tenants (not shown) that are being managed by the regional NNM systems 502.

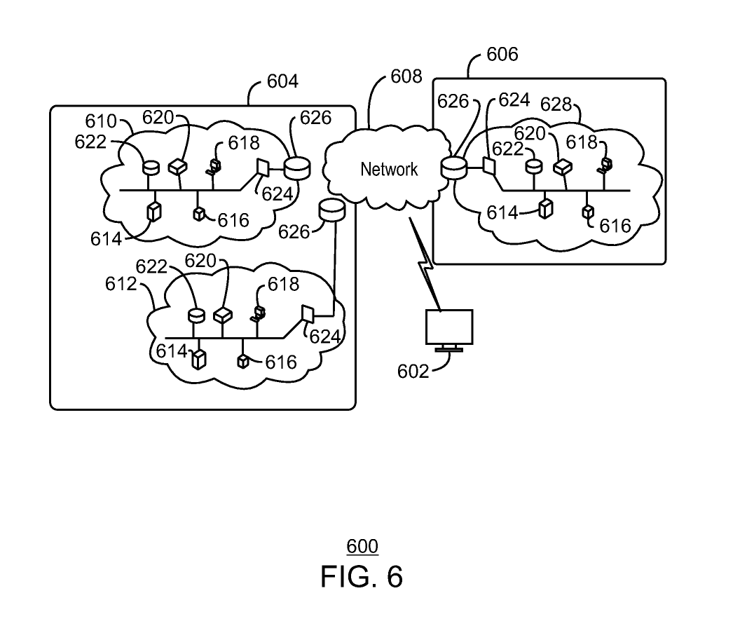

FIG. 6 is a schematic of a NAT environment 600 in which an NNM system 602 is used to monitor a first tenant 604 and a second tenant 606. The NNM system 602 may be communicably coupled to the tenants 604 and 606 via a network 608, such as a WAN, LAN, or the Internet. The NNM system 602 may be a corporate-level management station, and each of the tenants 604 or 606 represents the address domain(s) of a particular customer within the corporate environment.

The first tenant 604 may include a first OAD 610 and a second OAD 612. The first OAD 610 and the second OAD 612 may be included within the same tenant 604 as long as there are no overlapping IP addresses between the first OAD 610 and the second OAD 612. The first OAD 610 and the second OAD 612 may each include any number of network devices, such as a server 614, a printer 616, a personal computer (PC) 618, a router 620, or a gateway device 622, among others.

The first OAD 610 and the second OAD 612 may each be communicably coupled to a corresponding gateway device 626, which may include a router, a firewall, or any other type of NAT-capable gateway device. The gateway devices 626 may provide for the transmission of network communications between the network devices 614-622 of the first OAD 610 or the second OAD 612 and the NNM system 602. In addition, the first OAD 610 and the second OAD 612 may each include a firewall 624 that is configured to permit or deny network transmissions between the first OAD 610 or the second OAD 612, respectively, and the network 608.

The second tenant 606 may include a third OAD 628. The third OAD 628 may include the same or similar components as the first OAD 610 and the second OAD 612, as discussed above. However, the third OAD 628 may not be included within the first tenant 604, and, thus, the third OAD 628 may include IP addresses that overlap with the IP addresses of the first OAD 610 or the second OAD 612.

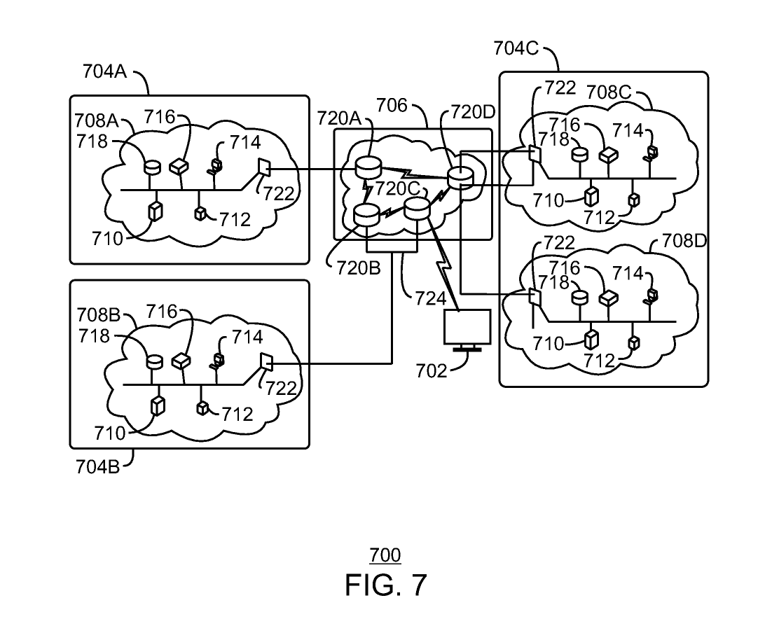

FIG. 7 is a schematic of a NAT environment 700 in which an NNM system 702 is used to monitor a number of tenants 704A, 704B, 704C, and 704D. Each of the tenants 704 may include inter-connectivity with a default tenant 706 that is communicably coupled to the NNM system 700. However, the tenants 704 may not include inter-connectivity with each other.

Each of the tenants 704 may include one or more OADs 708A, 708B, 708C, and 708D. Each of the OADs 708 may include any number of network devices, such as a server 710, a printer 712, a PC 714, a router 716, or a gateway device 718, among others. Each OAD 708 may be communicably coupled to a corresponding gateway device 720, which may include a router, a firewall, or any other type of NAT-capable gateway device. The gateway devices 720 may provide for the transmission of network communications between the network devices 710-718 of each of the OADs 708 and the NNM system 702. In addition, each OAD 708 may include a firewall 722 that is configured to permit or deny network transmissions between each of the OADs 708 and the NNM system 702.

In some examples, one of the tenants 704, e.g., the tenant 704C, includes two or more OADs 708, e.g., the OADs 708C and 708D. For example, the tenant 704C may represent a particular customer within a corporate environment, and the OADs 708C and 708D may be related to the customer. In addition, the OADs 708C and 708D within the tenant 704C include unique, non-overlapping address domains. This may ensure that the tenant 704C does not include multiple network devices with the same IP address.

The gateway devices 720 may be included within the default tenant 706. Each OAD 708 may have multiple links to one gateway device 720, or may be communicably coupled to multiple gateway devices 720. The gateway devices 720 within the default tenant 706 may be configured to directly communicate with the NNM system 702. In addition, the inclusion of the gateway devices 720 within the default tenant 706 may allow for the simultaneous monitoring of the entire network via the NNM system 702. For example, network communications from the gateway devices 720 may be used by the NNM system 702 to generate network topology information.

In some examples, the NAT environment 700 includes router redundancy groups (RRGs). In other words, two or more of the gateway devices 720, e.g., the gateway devices 720B and 720C, may be communicably coupled via any number of redundancy components 724. The redundancy components 724 may include redundancy protocols that ensure fault tolerance, such as, for example, a Hot Standby Router Protocol (HSRP).

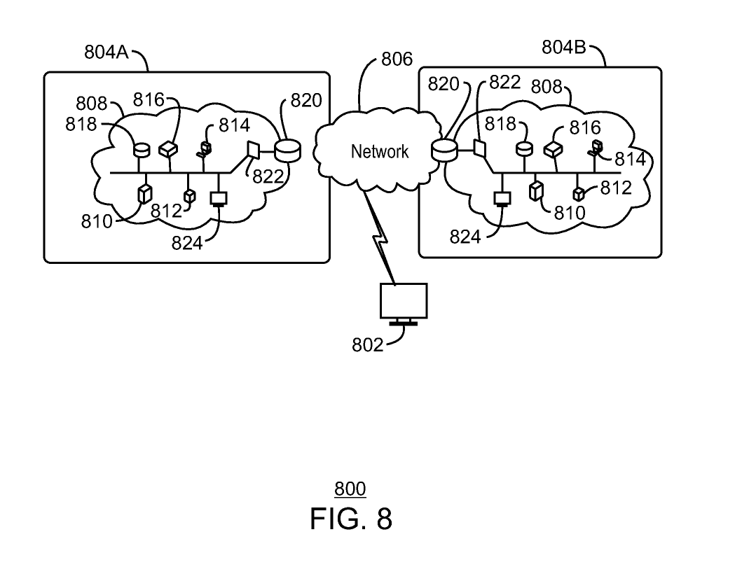

FIG. 8 is a schematic of a dynamic NAT environment 800 in which a global NNM system 802 is used to monitor a number of tenants 804. The NNM system 802 may be communicably coupled to the tenants 804 via a network 806, such as a WAN, LAN, or the Internet. Each tenant 804 may include one or more OADs 808, as shown in FIG. 8. In addition, one of the tenants 804, e.g., the tenant 804A, may be a dynamic NAT tenant, while the other tenant 804, e.g., the tenant 804B, may be a dynamic PAT tenant.

Each OAD 808 may include a number of network devices, such as a server 810, a printer 812, a PC 814, a router 816, or a gateway device 818, among others. Each OAD 808 may be communicably coupled to a corresponding gateway device 820, which may include a router, a firewall, or any other type of NAT-capable gateway device. The gateway devices 820 may provide for the transmission of network communications between the network devices 810-818 of each of the OADs 808 and the NNM system 802. In addition, each OAD 808 may include a firewall 822 that is configured to permit or deny network transmissions between each of the OADs 808 and the NNM system 802.

According to the dynamic NAT environment 800 shown in FIG. 8, each OAD 808 may also include a regional NNM system 824. The regional NNM systems 824 may be used to monitor the network devices 810-818 within the corresponding OAD 808. The regional NNM systems 824 may send specific information regarding the corresponding tenant 804 to the global NNM system 802. The global NNM system 802 may use such information to monitor the overall state, or health, of the network devices 810-818.

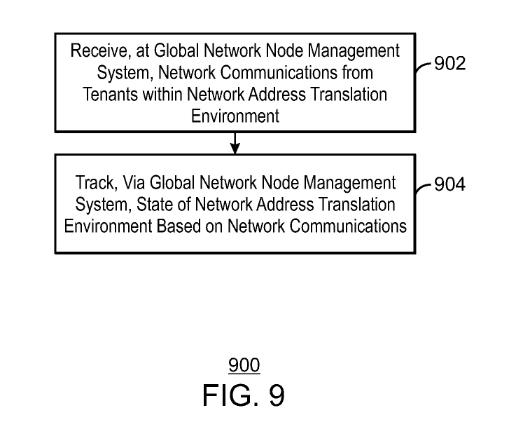

FIG. 9 is a process flow diagram showing a method 900 for managing OADs using a global NNM system. The method 900 may be implemented, for example, within any of NAT environments discussed above with respect to FIGS. 2-4 and 6-8. For example, the NAT environment may be a static NAT environment or a dynamic NAT environment, such as a PAT environment. Further, in some examples, the method 900 is implemented within a cloud computing environment.

The method begins at block 902, at which network communications are received at a global NNM system from multiple tenants within a NAT environment. The tenants may each include a group of network devices with non-overlapping IP addresses. According to examples described herein, the tenants each have a single address domain space. A single tenant may also include multiple OADs as long as there are no overlapping IP addresses between the multiple OADs within the tenant.

The global NNM system may include a public IP address. In addition, each tenant may include a gateway device that includes a corresponding public IP address for communicating with the global NNM system. However, each tenant may also include a number of non-overlapping, private IP addresses. In some examples, an overlapping address mapping (OAM) process may be performed to store the mapping between the public and private IP addresses within the NAT environment. The OAM process may be a user specified external to internal address pairing procedure within a tenant. In addition, the OAM process may be configurable for user interface (UI) or command-line interface (CLI) applications.

In some examples, the OAM process may allow for the determination of the management IP address for a network node that does not communicate via Simple Network Management Protocol (SNMP). For example, for a non-SNMP network node, the global NNM system can use OAM to determine the corresponding internal address for the external address that the global NNM system uses to communicate with the network node. This enables the global NNM system to connect non-SNMP network nodes to other SNMP network nodes using Forwarding Database Entries found on upstream network nodes that correspond to the internal IP address.

In some examples, a tenant includes a regional NNM system communicably coupled to a group of network devices with non-overlapping IP addresses and a global NNM system. The regional NNM system may be configured to send network communications to the global NNM system. For example, the regional NNM system may send network device details to the global NNM system via real-time Java Message Service (JMS) messages.

The network communications may include information relating to a state, or health, of each network device within a tenant. The network communications may also include the inventory, status, and incidents for the NAT environment. In addition, the network communications may include data relating to network device configurations or status polls.

At block 904, a state of the NAT environment is tracked, or monitored, based on the network communications via the global NNM system. In some examples, tracking the state of the NAT environment based on the network communications includes automatically combining topology information from the tenants. In addition, tracking the state of the NAT environment may include monitoring a health of the network devices within the NAT environment. The global NNM system may be configured to monitor the state of a network device without directly accessing the network device.

In some examples, tracking the state of the NAT environment includes specifying, within the global NNM system, whether to receive network communications from each of the tenants. For example, an administrator of the global NNM system may be allowed to specify the tenants from which to receive network communications via a user interface.

It is to be understood that the process flow diagram of FIG. 9 is not intended to indicate that the steps of the method 900 are to be executed in any particular order, or that all of the steps of the method 900 are to be included in every case. Further, any number of additional steps not shown in FIG. 9 may be included within the method 900, depending on the specific application. For example, the method 900 may be used by an administrator of the global NNM system to configure, monitor, and manage the network devices within the NAT environment. Through the use of tenancy, this may be accomplished without reconfiguring network devices that would otherwise be seen as having replicated IP addresses.

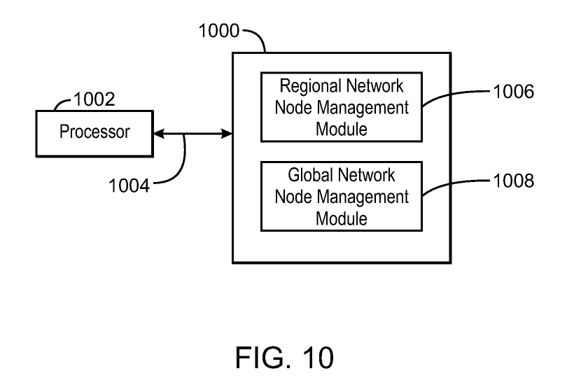

FIG. 10 is a block diagram showing a tangible, non-transitory, computer-readable medium 1000 that stores a protocol adapted to manage OADs within a NAT environment using one or more NNM systems. The tangible, non-transitory, computer-readable medium 1000 may be accessed by a processor 1002 over a computer bus 1004. Furthermore, the tangible, non-transitory, computer-readable medium 1000 may include code to direct the processor 1002 to perform the steps of the current method.

The various software components discussed herein may be stored on the tangible, non-transitory, computer-readable medium 1000, as indicated in FIG. 10. For example, a regional NNM module 1006 may be configured to direct the processor 1002 to perform local management of an OAD within a dynamic NAT environment. A global NNM module 1008 may be configured to direct the processor 1002 to perform remote management and monitoring of multiple OADs using information obtained via the regional NNM module 1006, as well as information obtained directly from OADs within a static NAT environment.

It is to be understood that FIG. 10 is not intended to indicate that all of the software components discussed above are to be included within the tangible, non-transitory, computer-readable medium 1000 in every case. Further, any number of additional software components not shown in FIG. 10 may be included within the tangible, non-transitory, computer-readable medium 1000, depending on the specific application.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for managing overlapping address domains, comprising:
receiving, at a global network node management system, network communications from a plurality of tenants within a network address translation (NAT) environment, wherein each of the plurality of tenants comprises a group of network devices with non-overlapping internet protocol (IP) addresses; and
tracking, via the global network node management system, a state of the NAT environment based on the network communications.

2. The method of claim 1, wherein the NAT environment comprises a static NAT environment.

3. The method of claim 1, wherein the NAT environment comprises a dynamic NAT environment.

4. The method of claim 3, wherein a tenant comprises a regional network node management system communicably coupled to:
a group of network devices with non-overlapping IP addresses; and
the global network node management system;
wherein the regional network node management system is configured to send network communications to the global network node management system.

5. The method of claim 1, wherein the method is implemented within a cloud computing environment.

6. The method of claim 1, wherein tracking the state of the NAT environment based on the network communications comprises automatically combining topology information from the plurality of tenants.

7. The method of claim 1, comprising specifying, within the global network node management system, whether to receive network communications from each of the plurality of tenants.

8. The method of claim 7, comprising allowing an administrator of the global network node management system to specify the plurality of tenants from which to receive network communications via a user interface.

9. A system for managing overlapping address domains, comprising:
a plurality of groups of network devices within a network address translation (NAT) environment, wherein each of the plurality of groups comprises network devices with non-overlapping internet protocol (IP) addresses, and wherein each of the plurality of groups is communicably coupled to one of a plurality of regional network node management systems; and
a global network node management system that is communicably coupled to each regional network node management system, wherein the global network node management system is configured to receive network communications from each regional network node management system.

10. The system of claim 9, wherein the NAT environment comprises a dynamic NAT environment.

11. The system of claim 9, comprising a plurality of groups of network devices within a static NAT environment, wherein each of the plurality of groups of network devices is communicably coupled to the global network node management system.

12. The system of claim 9, wherein each of the plurality of groups of network devices comprises one of a plurality of tenants.

13. The system of claim 12, comprising a default tenant, wherein the default tenant comprises gateway devices for communicably coupling each of the plurality of tenants within the NAT environment.

14. The system of claim 13, wherein the NAT environment is configured to:
support cross-tenant connectivity between the default tenant and any of the plurality of tenants; and
prevent direct cross-tenant connectivity between any of the plurality of tenants.

15. The system of claim 9, wherein the NAT environment comprises a port address translation (PAT) environment.

16. The system of claim 9, comprising a plurality of routers and a plurality of network switches configured to:
communicably couple the networks devices within each of the plurality of groups;
communicably couple the plurality of groups to the plurality of regional network node management systems; and
communicably couple each regional network node management system to the global network node management system.

17. The system of claim 9, wherein the network communications from a regional network node management system comprise information relating to a state of each network device within a group.

18. A tangible, non-transitory, computer-readable medium comprising code configured to direct a processor to:
receive, at a global network node management system, network communications from a plurality of regional network node management systems within a first network address translation (NAT) environment, wherein each of the plurality of regional network node management systems is communicably coupled to a group of network devices with non-overlapping internet protocol (IP) addresses;
receive network communications from a plurality of groups of network devices within a second NAT environment, wherein each of the plurality of groups comprises network devices with non-overlapping IP addresses; and
monitor a state of the first NAT environment and the second NAT environment based on the network communications.

19. The tangible, non-transitory, computer-readable medium of claim 18, wherein each of the plurality of groups of network devices comprises a tenant with a single address domain space.

20. The tangible, non-transitory, computer-readable medium of claim 18, wherein the first NAT environment comprises a dynamic NAT environment, and wherein the second NAT environment comprises a static NAT environment.
